(19) United States
(12) Patent Application Publication
(10) Pub. No.: US 2026/0153169 A1
(43) Pub. Date: Jun. 4, 2026

(54) GASKET FOR PIPE FITTING ASSEMBLY

(71) Applicant: ASC Engineered Solutions, LLC, Oak Brook, IL (US)

(72) Inventor: Daniel Cross, Wakefield, RI (US)

(21) Appl. No.: 18/968,588

(22) Filed: Dec. 4, 2024

(51) Int. Cl. F16L 17/025

(52) U.S. Cl. CPC F16L 17/025

(57) ABSTRACT

An annular gasket for a fitting assembly includes a gasket inner surface defining a gasket void and a central rib extending radially inward into the gasket void, a gasket axis extending centrally through the gasket void; a gasket outer surface defining a first gasket shoulder extending radially outward at a first axial end of the annular gasket and a second gasket shoulder extending radially outward at a second axial end of the annular gasket opposite the first axial end; a first sealing ridge extending radially inward at the first axial end of the annular gasket; and a second sealing ridge extending radially inward at the second axial end of the annular gasket, wherein the central rib is positioned axially between the first sealing ridge and the second.

### TECHNICAL FIELD

This disclosure relates to piping. More specifically, this disclosure relates to a gasket for a pipe fitting assembly.

### BACKGROUND

Pipe fittings, such as pipe couplings, are commonly used to connect two sections of pipes or other pipe fittings, such as valves, together to form a pipe connection, such as when installing a pipe system or a pipe infrastructure. Pipe fittings often comprise a gasket configured to seal with the two pipe sections. Pipe sections can comprise varying outer diameters where the pipe section is to be engaged with the pipe fitting. The outer diameters of pipe sections can vary, for example, based on size of the pipe section and/or the material(s) of the pipe section. Often, the gasket of the pipe fitting is not able to accommodate varying outer diameters and/or can only accommodate a small range of varying outer diameters.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is an annular gasket for a fitting assembly, the annular gasket comprising a gasket inner surface defining a gasket void and a central rib extending radially inward into the gasket void, a gasket axis extending centrally through the gasket void; a gasket outer surface defining a first gasket shoulder extending radially outward at a first axial end of the annular gasket and a second gasket shoulder extending radially outward at a second axial end of the annular gasket opposite the first axial end; a first sealing ridge extending radially inward at the first axial end of the annular gasket; and a second sealing ridge extending radially inward at the second axial end of the annular gasket, wherein the central rib is positioned axially between the first sealing ridge and the second.

Also disclosed is a fitting assembly comprising a pipe fitting comprising a first fitting segment and a second fitting segment, the first and second fitting segments defining a fitting inner surface of the pipe fitting, the fitting inner surface defining a coupling void and a substantially annular coupling channel; and a gasket received with the substantially annular coupling channel, the gasket defining a gasket outer surface, the gasket outer surface defining a first gasket shoulder and a second gasket shoulder, the gasket further comprising a first sealing ridge extending radially inward from the first gasket shoulder and a second sealing ridge extending radially inward from the second gasket shoulder; wherein the fitting assembly is configurable in an untightened configuration and a tightened configuration, and wherein, in the tightened configuration, the fitting inner surface is pressed against the first and second gasket shoulders to bias the first and second sealing ridges radially inward.

Additionally, disclosed is a method of assembling a fitting assembly, the method comprising providing an annular gasket, the annular gasket comprising defining a gasket outer surface and a gasket inner surface, the gasket outer surface defining a first gasket shoulder and a second gasket shoulder, the annular gasket further comprising a first sealing ridge extending radially inward from the first gasket shoulder and a second sealing ridge extending radially inward from the second gasket shoulder, the inner gasket surface defining a gasket void; inserting a first end of a first piping component into the gasket void at a first gasket axial end of the annular gasket; inserting a second end of a second pipe component into the gasket void at a second gasket axial end of the annular gasket, opposite the first gasket axial end; and tightening a pipe fitting around the annular gasket to press the pipe fitting radially inward against the first gasket shoulder and the second gasket shoulder; wherein pressing the pipe fitting radially inward against the first gasket shoulder and the second gasket shoulder comprises biasing the first sealing ridge and the second sealing ridge radially inward to seal against the first sealing ridge against the first pipe component and the second sealing ridge against the second pipe component.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a perspective view of a coupling assembly, in accordance with one aspect of the present disclosure, wherein the coupling assembly is assembled with a pair of pipe sections in a tightened configuration.

FIG. 2 is a front view of the coupling assembly of FIG. 1 in the tightened configuration.

FIG. 3 is a perspective view of a first coupling segment and a gasket of the coupling assembly of FIG. 1 assembled with the pair of pipe sections.

FIG. 4 is a perspective view of the gasket of FIG. 3.

FIG. 5 is a cross-sectional view of the gasket of FIG. 3 taken along line 5-5 in FIG. 4.

FIG. 6 is a cross-sectional view of the coupling assembly of FIG. 1 taken along line 6-6 in FIG. 1, wherein the coupling assembling is assembled with the pair of pipe sections in an untightened configuration.

FIG. 7 is a cross-sectional view of the coupling assembly of FIG. 1 taken along line 6-6 in FIG. 1, wherein the coupling assembling is assembled with the pair of pipe sections in the tightened configuration.

FIG. 8 illustrates a perspective view of the gasket, in accordance with another aspect of the present disclosure.

FIG. 9 is a cross-sectional view of the gasket of FIG. 8 taken along line 9-9 in FIG. 8.

FIG. 10 is a cross-sectional view of the coupling assembly according another aspect of the present disclosure, the cross-sectional view taken along a line similar to line 6-6 in FIG. 1, wherein the coupling assembling comprises the gasket of FIG. 8 and is assembled with the pair of pipe sections in the untightened configuration.

FIG. 11 is a cross-sectional view of the coupling assembly of FIG. 10 taken along a line similar to line 6-6 in FIG. 1, wherein the coupling assembling is assembled with the pair of pipe sections in the tightened configuration.

FIG. 12 is a perspective view of the coupling assembly, in accordance with another aspect of the present disclosure, wherein the coupling assembly is assembled with a pair of pipe sections.

FIG. 13 is a cross-sectional view of the coupling assembly of FIG. 12 taken along line 13-13 in FIG. 12, wherein the coupling assembling is assembled with the pair of pipe sections in the untightened configuration.

FIG. 14 is a cross-sectional view of the coupling assembly of FIG. 12 taken along line 13-13 in FIG. 12, wherein the coupling assembling is assembled with the pair of pipe sections in the tightened configuration.

### DETAILED DESCRIPTION

The present disclosure can be understood more readily by reference to the following detailed description, examples, drawings, and claims, and the previous and following description. However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a fitting assembly and associated methods, systems, devices, and various apparatus. Example aspects of the fitting assembly can comprise a pipe fitting and an annular gasket. It would be understood by one of skill in the art that the fitting assembly is described in but a few exemplary embodiments among many. No particular terminology or description should be considered limiting on the disclosure or the scope of any claims issuing therefrom.

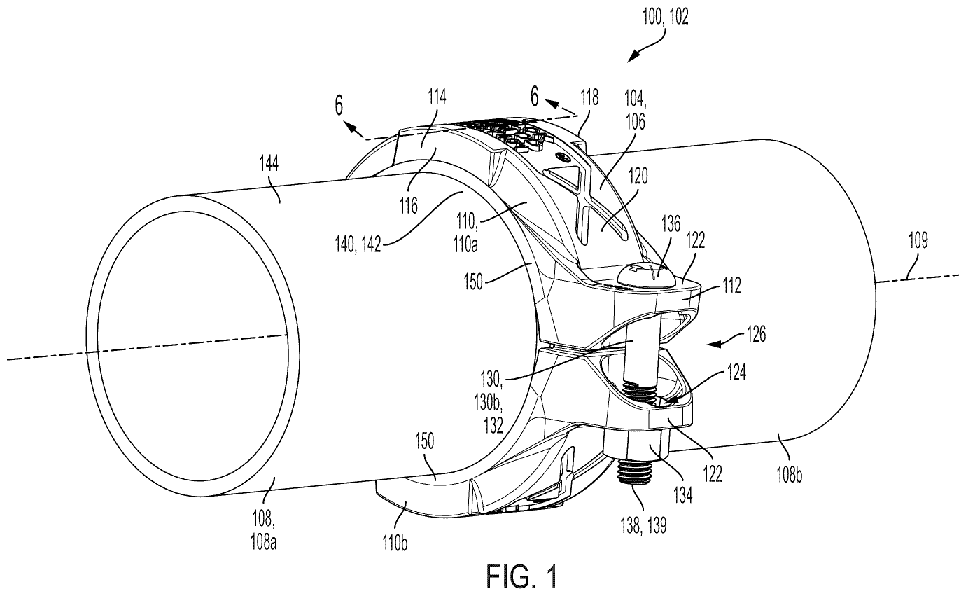

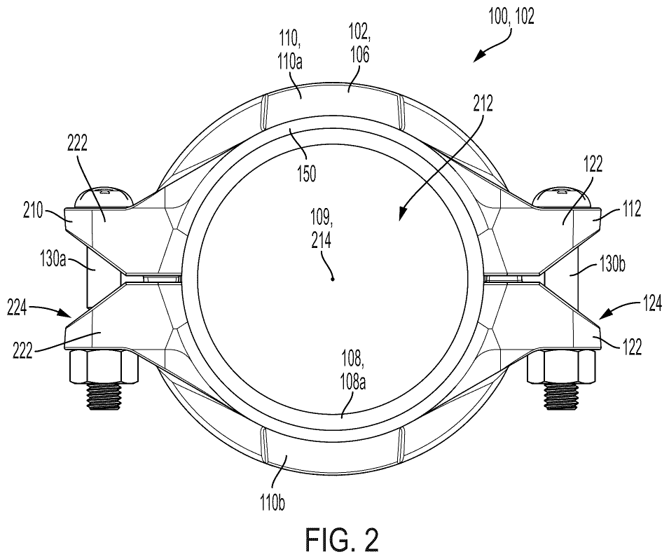

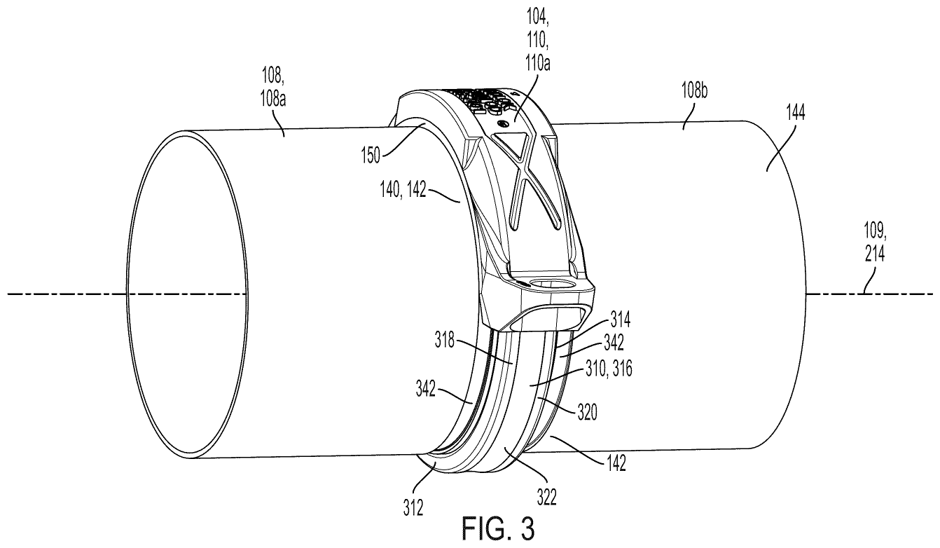

FIG. 1 illustrates a perspective view and FIG. 2 illustrates a front view of a fitting assembly 100 according to an example aspect of the present disclosure. The fitting assembly 100 can comprise a pipe fitting 104 and an annular gasket 310 (shown in FIG. 3). Example aspects of the pipe fitting 104 can be connected to one or more pipe sections 108 in a tightened configuration, as shown. In other aspects, the pipe fitting 104 can be connected to other piping component, including but not limited to, other fittings, valves, meters, or any other suitable piping structure. The pipe fitting 104 can be any suitable type of fitting, including but not limited to, a coupler, adapter, tee, elbow, flange, pipe coupling, pipe clamp, and the like. In the present aspect, the fitting assembly 100 can be a coupling assembly 102, and the pipe fitting 104 can be a pipe coupling 106. The pipe fitting 104 can be configured to connect together a first pipe section 108a and a second pipe section 108b. A piping axis 109 can extend centrally through the first and second pipe sections 108a,b, as shown.

Example aspects of the pipe coupling 106 can comprise a first fitting segment, such as an upper coupling segment 110a, and a second fitting segment, such as a lower coupling segment 110b. The upper and lower coupling segments 110a,b can be identical in the present aspect, and when assembled together, the upper and lower coupling segments 110a,b can be mirror images of one another. Each of the upper and lower coupling segments 110a,b can be substantially C-shaped in the present aspect. In other aspects, the pipe coupling 106 can comprise more or fewer coupling segments 110. Each of the upper and lower coupling segments 110a,b can define a first end 210 (shown in FIG. 2), a second end 112 opposite the first end 210, and a central section 114 extending between the first end 210 and second end 112.

Each of the upper and lower coupling segments 110a,b can further define a front axial end 116 and a rear axial end 118 opposite the front axial end 116. Each of the upper and lower coupling segments 110a,b can also define a segment outer surface 120 and a segment inner surface 620 (shown in FIG. 6) opposite the segment outer surface 120. The segment inner surface 620 of the upper coupling segment 110a can face the segment inner surface 620 of the lower coupling segment 110b. The segment inner surfaces 620 of the upper and lower coupling segments 110a,b can together define a substantially annular coupling inner surface 630 (shown in FIG. 6) of the pipe coupling 106. The coupling inner surface 630 can define a coupling void 212 (shown in FIG. 2) between the central sections 114. The annular gasket 310 can be arranged within the coupling void 212. A coupling axis 214 (shown in FIG. 2, going into the page) can extend centrally through the coupling void 212 and the annular gasket 310, and can be substantially coaxial with the piping axis 109. The first pipe section 108a can engage the coupling void 212 at the front axial ends 116 of the pipe coupling 106, and the second pipe section 108b can engage the coupling void 212 at the rear axial ends 118 of the pipe coupling 106. The annular gasket 310 can be configured to seal around the first and second pipe sections 108a,b, as described in further detail below.

According to example aspects, each of the upper and lower coupling segments 110a,b can be formed by a casting process. In some aspects, the upper and lower coupling segments 110a,b can be cast in the same mold or in identical molds. In some aspects, the cast material of the upper and lower coupling segments 110a,b can comprise a metal material, such cast iron, including ductile iron in some aspects. In other example aspects, the upper and lower coupling segments 110a,b can be formed by any other suitable manufacturing process and/or from another suitable material, or a combination of materials, that are known in the art, including but not limited to other metals, plastics, composites, and the like.

A first fastener lug 222 (shown in FIG. 2) can be formed at the first end 210 of each of the upper and lower coupling segments 110a,b, and a second fastener lug 122 can be formed at the second end 112 of each of the upper and lower coupling segments 110a,b. The central section 114 can define a substantially arcuate shape and can extend between the corresponding first fastener lug 222 and second fastener lug 122. The first fastener lug 222 of the upper coupling segment 110a can be substantially aligned with the first fastener lug 222 of the lower coupling segment 110b, and the second fastener lug 122 of the upper coupling segment 110a can be substantially aligned with the second fastener lug 122 of the lower coupling segment 110b, relative to the orientation shown. Each of the first fastener lugs 222 can define a first fastener opening 224 (shown in FIG. 2) formed therethrough, and each of the second fastener lugs 122 can define a second fastener opening 124 formed therethrough.

The upper and lower coupling segments 110a,b can be secured together by the one or more fasteners 130. For example, the fasteners 130 can comprise a first fastener 130a (shown in FIG. 2) and a second fastener 130b. The first fastener 130a can be configured to extend through the each of the first fastener openings 224 to couple the upper and lower coupling segments 110a,b together at the first ends 210 thereof, and the second fastener 130b can be configured to extend through each of the second fastener openings 124 to couple the upper and lower coupling segments 110a,b together at the second ends 112 thereof. Each of the first and second fasteners 130a,b can be selectively tightened and loosened, to configure the coupling assembly 102 in the tightened configuration and an untightened configuration (shown in FIG. 6), respectively. In the present aspect, each of the first and second fasteners 130a,b can comprise a threaded bolt 132 and a threaded nut 134. The threaded bolt 132 can define a bolt head 136 and a bolt shaft 138 extending from the bolt head 136. The bolt shaft 138 can define shaft threading 139 distal to the bolt head 136.

Referring to the second fastener 130b, and wherein the following description can also be illustrative of the first fastener 130a, the bolt shaft 138 can extend through the second fastener opening 124 of the upper coupling segment 110a, and the bolt head 136 can face the segment outer surface 120 of the upper coupling segment 110a. The bolt head 136 can be sized to prohibit passage of the bolt head 136 through the second fastener opening 124 of the upper coupling segment 110a. The bolt shaft 138 can span a gap 126 defined between the second fastener lugs 122 and can extend through the second fastener opening 124 of the lower coupling segment 110b. The threaded nut 134 can be threaded onto the shaft threading 139 of the bolt shaft 138 distal to the bolt head 136 and can face the segment outer surface 120 of the lower coupling segment 110b. The threaded nut 134 can be sized to prohibit passage of the threaded nut 134 through the second fastener opening 124 of the lower coupling segments 110. To draw the second ends 112 of the upper and lower coupling segments 110a,b closer together, and to thus tighten the pipe coupling 106 onto the pipe sections 108, the threaded nut 134 can be tightened on the bolt shaft 138 by rotating the threaded nut 134 on the shaft threading 139 in a tightening direction. In other aspects, the first and second fasteners 130a,b can be any other suitable fastener known in the art, including screws, set screws, rivets, and the like.

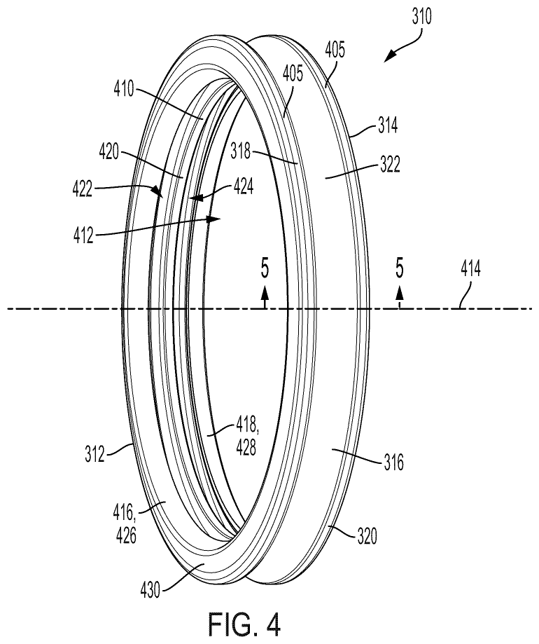

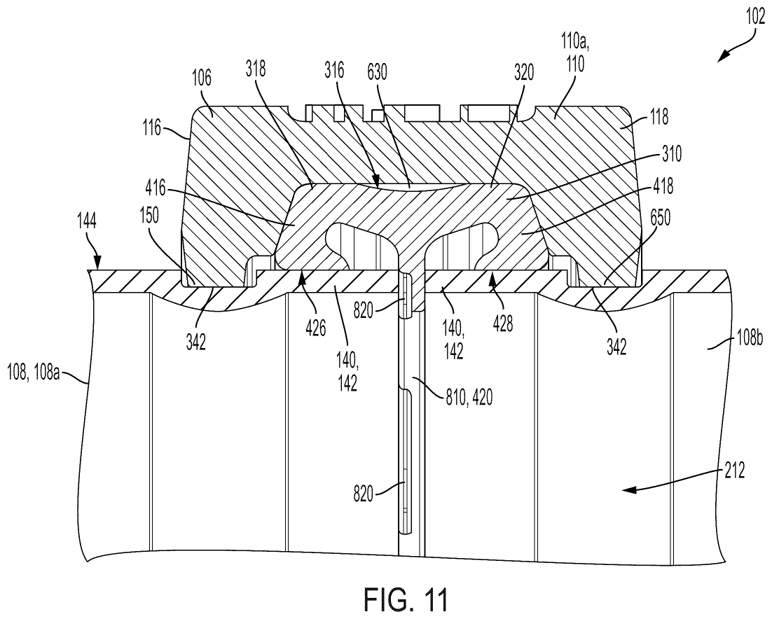

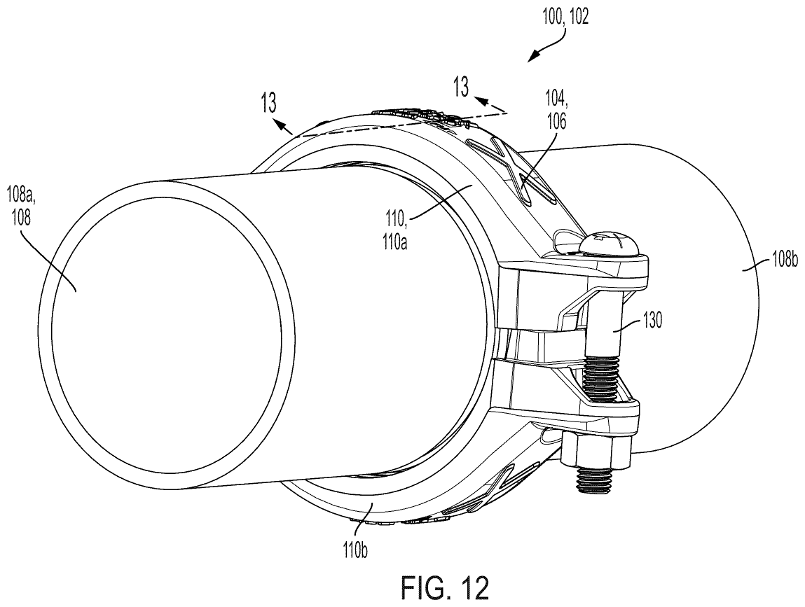

The coupling void 212 can be configured to receive opposing pipe ends 140 of the first and second pipe sections 108a,b, respectively, to couple the first pipe section 108a to the second pipe section 108b. The annular gasket 310 arranged within the coupling void 212 can wrap around and seal with the opposing pipe ends 140 of the first and second pipe sections 108a,b to create a fluid-tight seal between the first and second pipe sections 108a,b. In the present aspect and in the aspect of FIGS. 10 and 11, after the first and second pipe sections 108a,b are inserted into the annular gasket 310, the coupling segments 110 can be configured to be assembled around annular gasket 310 and the joint between the first pipe section 108a and the second pipe section 108b. In other aspects, the pipe coupling 106, the annular gasket 310, and the first pipe section 108a can be initially assembled together in a pre-assembled configuration and can then receive the corresponding end of the second pipe section 108b to join the first pipe section 108a to the second pipe section 108b. In other aspects, such as the aspect of FIGS. 12-14, the annular gasket 310 and pipe coupling 106 can be pre-assembled, and then can be placed onto and slid over the pipe end 140 of the first pipe section 108a. The second pipe section 108b can then be aligned with the first pipe section 108a, and the coupling segments 110 can be slid back over the pipe end 140 of the second pipe section 108b to cover the joint. In other aspects, each pipe end 140 of the first and second pipe sections 108a,b can be inserted into the annular gasket 310 in the pre-assembled pipe coupling 106 until each pipe end contacts a center rib 420 (shown in FIG. 4).

In the present aspect, each of the coupling segments 110 can define a first arcuate key 150 extending along the central section 114 at the front axial end 116 and a second arcuate key 650 (shown in FIG. 6) opposite the first arcuate key 150 and extending along the central section 114 at the rear axial end 118. In some aspects, the opposing pipe ends 140 of the first pipe section 108a and/or the second pipe section 108b can define grooved or shouldered ends 142, and the first and second arcuate keys 150,650 of the coupling segments 110 can engage the grooved or shouldered ends 142 when the coupling segments 110 are drawn together by tightening the one or more fasteners 130, as described in further detail below with respect to FIG. 6. In other aspects, however, the opposing pipe ends 140 of first pipe section 108a and/or second pipe section can define plain ends, and the first and second arcuate keys 150,650 can grip an outer pipe surface 144 of the plain ends of the pipe sections 108. Plain ends can be ends that do not define a designated groove or shoulder to be engaged by the arcuate keys 150,650.

FIG. 3 illustrates the pipe fitting 104 after the annular gasket 310 is installed on the pipe sections 108a,b, and during installation of the coupling segments 110 around the annular gasket 310, with the upper coupling segment 110a placed on annular gasket 310 and the lower coupling segment 110b (shown in FIG. 1) not yet attached to the upper coupling segment 110a. As shown, the annular gasket 310 can wrap around and hug the outer pipe surface 144 of the first and second pipe sections 108a,b at the confronting grooved ends 142 to create the fluid-tight seal therebetween. The annular gasket 310 can thereby prevent fluid that is flowing between the first and second pipe sections 108a,b (e.g., liquid or gas) from leaking out at the joint therebetween. The annular gasket 310 can also aid in maintaining the pipe ends 140 of the first and second pipe sections 108a,b in proper alignment and confrontation. As shown, the outer pipe surface 144 of each of the first and second pipe sections 108a,b can define a substantially annular pipe groove 342 at the corresponding grooved end 142. The first arcuate keys 150 of the coupling segments 110 can be configured to engage the annular pipe groove 342 of the first pipe section 108a, and the second arcuate keys 650 (shown in FIG. 6) of the coupling segments 110 can be configured to engage the annular pipe groove 342 of the second pipe section 108b to couple the first and second pipe sections 108a,b together.

The annular gasket 310 can be positioned within the coupling void 212 (shown in FIG. 2) between the first and second arcuate keys 150,650 of the coupling segments 110, as shown. Example aspects of the annular gasket 310 comprise a resilient, flexible material. For example, in some aspects, the annular gasket 310 can comprise a rubber material such as EPDM rubber. In other aspects, the annular gasket 310 can comprise any suitable flexible and resilient material or combination of materials known in the art, including but not limited to, various types of rubbers, foams, plastics, cork, wood, metal, elastomers, polymers, and the like.

According to example aspects, the annular gasket 310 can define a gasket first axial end 312 and a gasket second axial end 314 opposite the gasket first axial end 312. The annular gasket 310 can define a gasket inner surface 410 (shown in FIG. 4) and a gasket outer surface 316 opposite the gasket inner surface 410. In an uncompressed configuration of the annular gasket 310, the gasket outer surface 316 can define an annular first gasket shoulder 318 extending radially outward at the gasket first axial end 312 and an annular second gasket shoulder 320 radially outward at the gasket second axial end 314. The gasket outer surface 316 can further define an annular, substantially concave gasket center groove 322 arcing radially inward between the first and second gasket shoulders 318,320, as described in further detail below.

In some examples, the annular gasket 310 may be installed by stretching the annular gasket 310 over the pipe sections 108a,b and moving the annular gasket 310 into a sealing position. The coupling segments 110 are then installed over the annular gasket 310. In some other examples, the annular gasket 310 and the coupling segments 110 are assembled into a ready-to-install assembly, which is slid over the pipe sections 108a,b as an assembly. When the assembly is positioned correctly, the coupling segments 110 are secured to couple the pipe sections 108a,b and seal the gap between the pipe sections 108a,b.

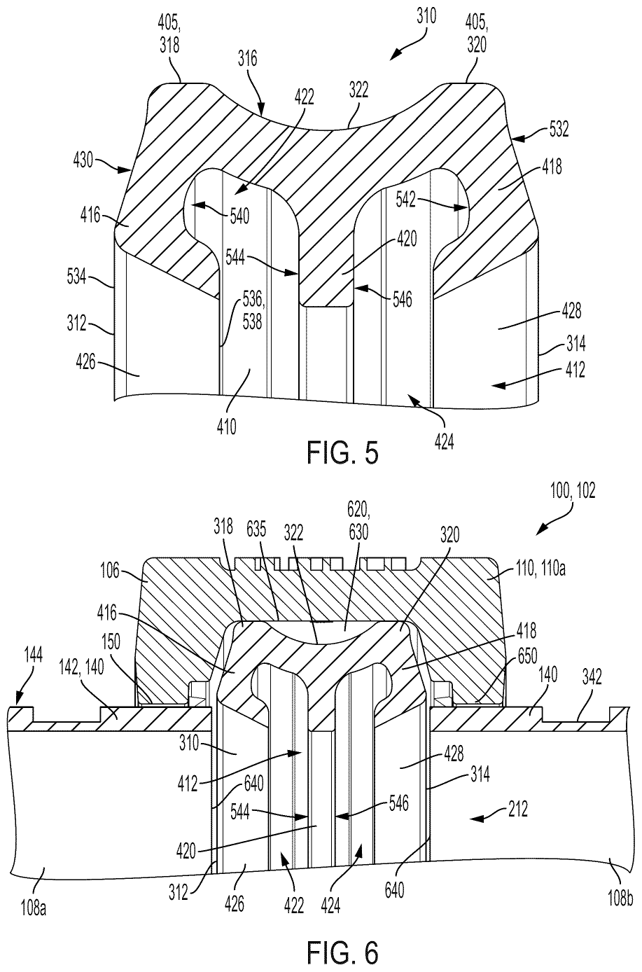

FIG. 4 illustrates a perspective view of the annular gasket 310, and FIG. 5 illustrates a cross-sectional view of the annular gasket 310 taken along line 5-5 in FIG. 4. Example aspects of the annular gasket 310 can define the gasket first axial end 312, the gasket second axial end 314, the gasket inner surface 410, and the gasket outer surface 316. The gasket inner surface 410 can define a gasket void 412, and a gasket axis 414 can extend centrally through the gasket void 412. When the pipe coupling 106 (shown in FIG. 1) is assembled, the gasket axis 414 can be substantially coaxial with the coupling axis 214 (shown in FIG. 2) and the piping axis 109 (shown in FIG. 1). The gasket outer surface 316 can define the first gasket shoulder 318 extending radially outward at the gasket first axial end 312, the second gasket shoulder 320 extending radially outward at the gasket second axial end 314, and the substantially concave gasket center groove 322 arranged axially therebetween. In some aspects, each of the first and second gasket shoulders 318,320 can define a substantially flat profile at a radially outer peak 405 thereof, as best seen in FIG. 5. In other aspects, the first and second gasket shoulders 318,320 can define a substantially rounded or arcuate profile at the radially outer peaks 405 thereof.

In example aspects, the annular gasket 310 can further comprise a first sealing ridge 416, a second sealing ridge 418, a central rib 420, a first gasket channel 422, and a second gasket channel 424. The first sealing ridge 416 can extend radially inward from the first gasket shoulder 318 at the gasket first axial end 312, and the second sealing ridge 418 can extend radially inward from the second gasket shoulder 320 at the gasket second axial end 314. Each of the first and second sealing ridges 416,418 can be substantially annular, as shown. Moreover, each of the first and second sealing ridges 416,418 can be substantially L-shaped in the present aspect. The gasket inner surface 410 can define a first ridge sealing surface 426 of the first sealing ridge 416 and a second ridge sealing surface 428 of the second sealing ridge 418. The gasket inner surface 410 can further define the central rib 420 arranged axially between the first sealing ridge 416 and the second sealing ridge 418 and extending radially into the gasket void 412. The first gasket channel 422 can be formed axially between the first sealing ridge 416 and the central rib 420, and the second gasket channel 424 can be formed axially between the second sealing ridge 418 and the central rib 420.

According to example aspects, the first sealing ridge 416 can define a drafted first outer ridge side surface 430 angling axially outward and away from the central rib 420, and the second sealing ridge 418 can define a drafted second outer ridge side surface 532 (shown in FIG. 5) angling axially outward and away from the central rib 420. Additionally, the first ridge sealing surface 426 of the first sealing ridge 416 can be a drafted surface angling axially inward towards the central rib 420, and the second ridge sealing surface 428 of the second sealing ridge 418 can be a drafted surface angling axially inward towards the central rib 420. In other aspects, the first and second outer ridge side surfaces 430,532 of the first and second sealing ridges 416,418 can be oriented substantially perpendicular to the gasket axis 414 and/or the first and second ridge sealing surfaces 426,428 of the first and second sealing ridges 416,418 can be oriented substantially parallel to the gasket axis 414 in the uncompressed configuration.

Referring to FIG. 5, in some aspects, an axially outward end 534 of each of the first and second ridge sealing surfaces 426,428 can be rounded or chamfered or otherwise shaped to facilitate the insertion of the first and second pipe sections 108a,b. Moreover, in some aspects, an axially inward end 536 of each of the first and second ridge sealing surfaces 426,428 can terminate in a ridge tip 538. The ridge tip 538 can be substantially sharp or angular, as shown, or can be rounded or chamfered in other aspects. The first and second ridge sealing surfaces 426,428 can be configured to contact and seal with the corresponding outer pipe surfaces 144 (shown in FIG. 1) of the first and second pipe sections 108a,b (shown in FIG. 1), respectively, to provide a fluid-tight seal therebetween, as described in further detail below.

The first and second gasket channels 422,424 can be arranged axially inward from and proximate to the first and second sealing ridges 416,418, respectively. In some example aspects, as shown, the first gasket channel 422 can extend into a first inner ridge side surface 540 of the first sealing ridge 416 to define the L-shape of the first sealing ridge 416, and the second gasket channel 424 can extend into a second inner ridge side surface 542 of the second sealing ridge 418 to define the L-shape of the second sealing ridge 418. When the first and second sealing ridges 416,418 contact the outer pipe surfaces 144 of the first and second pipe sections 108a,b, the first and second gasket channels 422,424 can allow fluid pressure to aid in sealing the corresponding first and second ridge sealing surfaces 426,428 against the outer pipe surfaces 144.

The central rib 420 can be arranged axially between the first and second gasket channels 422,424 and can extend radially into the gasket void 412. The central rib 420 can define a first rib side surface 544 adjacent to the first gasket channel 422 and an opposite second rib side surface 546 adjacent to the second gasket channel 424. An inward pipe edge 640 (shown in FIG. 6) at the pipe end 140 of the first pipe section 108a can be configured to annularly abut and seal with the first rib side surface 544 of the central rib 420, and the inward pipe edge 640 at the pipe end 140 of the second pipe section 108b can be configured to annularly abut and seal with the second rib side surface 546 of the central rib 420. The sealing contact between the pipe ends 140 of the first and second pipe sections 108a,b and the central rib 420 can aid in preventing or limiting fluid from flowing into the first and second gasket channels 422,424. Moreover, the positioning of the central rib 420 between the pipe ends 140 of the first and second pipe sections 108a,b can maintain the inward pipe edges 640 of the first and second pipe sections 108a,b in proper spacing from one another.

FIG. 6 illustrates a cross-sectional view of the coupling assembly 102 taken along line 6-6 in FIG. 1, wherein the coupling assembly 102 is in the untightened configuration (i.e., either or both of the fasteners 130, shown in FIG. 1, are loosened) and the pipe ends 140 of the first and second pipe sections 108a,b are not yet fully inserted into the coupling void 212. While the pipe coupling 106 is illustrated in the present view, in example aspects, the first and second pipe sections 108a,b can first be assembled with the annular gasket 310, with the pipe sections 108a,b fully inserted into the annular gasket 310, and the coupling segments 110 of the pipe coupling 106 can then be assembled around the already-assembled annular gasket 310 and first and second pipe sections 108a,b, with the arcuate keys 150,650 aligned axially with the annular pipe grooves 342.

The annular gasket 310 can define the first gasket shoulder 318 extending radially outward at the gasket first axial end 312, the second gasket shoulder 320 radially outward at the gasket second axial end 314, and the substantially concave gasket center groove 322 arcing radially inward between the first and second gasket shoulders 318,320. The annular gasket 310 can further define the first sealing ridge 416 extending radially inward from the first gasket shoulder 318, the second sealing ridge 418 extending radially inward from the second gasket shoulder 320, and the central rib 420 extending radially inward between the first sealing ridge 416 and the second sealing ridge 418. The first gasket channel 422 can be defined between the first sealing ridge 416 and the central rib 420, and the second gasket channel 424 can be defined between the second sealing ridge 418 and the central rib 420.

As shown, the pipe ends 140 of the first and second pipe sections 108a,b can be the grooved ends 142. Each of the grooved ends 142 can define the annular pipe groove 342 and the inward pipe edge 640. To assemble the first and second pipe sections 108a,b with the annular gasket 310, the pipe end 140 of the first pipe section 108a can be inserted into the gasket void 412 at the gasket first axial end 312 to abut and seal the inward pipe edge 640 of the first pipe section 108a against the first rib side surface 544 of the central rib 420, and the pipe end 140 of the second pipe section 108b can be inserted into the gasket void 412 at the gasket second axial end 314 to abut and seal the inward pipe edge 640 of the second pipe section 108b against the second rib side surface 546 of the central rib 420. In example aspects, the central rib 420 can be compressed between the inward pipe edges 640 of the first and second pipe sections 108a,b. The first ridge sealing surface 426 of the first sealing ridge 416 can contact and seal against the outer pipe surface 144 of first pipe section 108a, and the second ridge sealing surface 428 of the second sealing ridge 418 can contact and seal against the outer pipe surface 144 of the second pipe section 108b.

Once the first and second pipe sections 108a,b are assembled with the annular gasket 310, the coupling segments 110 of the pipe coupling 106 can be assembled around the annular gasket 310 in the untightened configuration. According to example aspects, the coupling inner surface 630 of the pipe coupling 106 can define a substantially annular coupling channel 635 of the pipe coupling 106, which can extend radially outward between the first and second arcuate keys 150,650 of the pipe coupling 106. The annular gasket 310 can be received within the substantially annular coupling channel 635 between the first and second arcuate keys 150,650, as shown. The pipe coupling 106 can then be tightened around the annular gasket 310 and the pipe ends 140 of the first and second pipe sections 108a,b. Tightening the pipe coupling 106 can comprise threading each of the threaded nuts 134 along the corresponding threaded bolt 132 towards the bolt head 136 (each of 132, 134, and 136 shown in FIG. 1) to draw the first fastener lugs 222 (shown in FIG. 2) towards one another and the second fastener lugs 122 (shown in FIG. 1) towards one another, thereby drawing the coupling segments 110 towards one another and reducing a diameter of the coupling void 212. Prior to tightening, in the untightened configuration, in some aspects, the first gasket shoulder 318 and the second gasket shoulder 320 can bias the first coupling segment away 110a from the second coupling segment 110b and/or away from the first pipe section 108a and the second pipe section 108b.

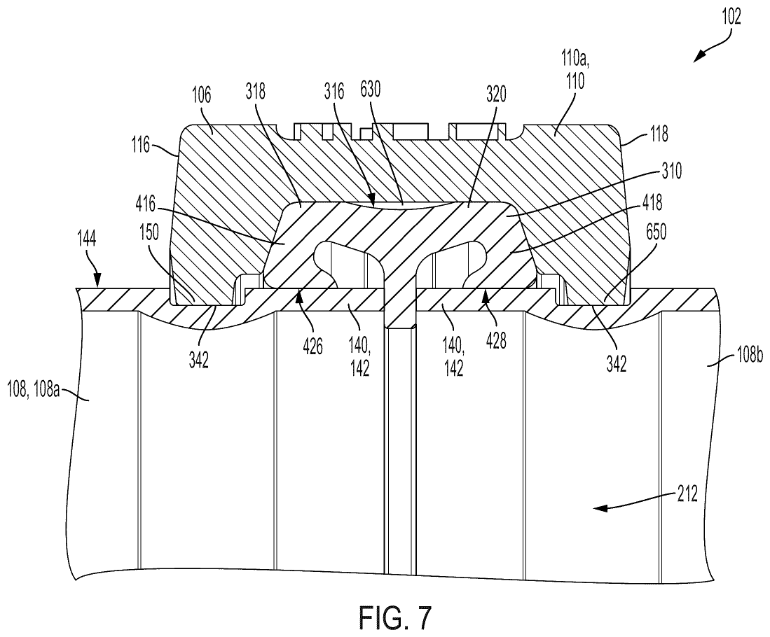

FIG. 7 illustrates a cross-sectional view of the fully assembled coupling assembly 102 in the tightened configuration. As illustrated, as the coupling segments 110 are drawn towards one other, the coupling inner surface 630 of the pipe coupling 106 can engage the gasket outer surface 316 of the annular gasket 310 and can bias the annular gasket 310 radially inward. The annular gasket 310 can thereby be compressed between the pipe coupling 106 and the first and second pipe sections 108a,b, improving the seal of the annular gasket 310 with the first and second pipe sections 108a,b. More specifically, as shown, the coupling inner surface 630 of the pipe coupling 106 can engage and press against the first and second gasket shoulders 318,320 of the annular gasket 310 to bias the first and second sealing ridges 416,418 radially inward against the outer pipe surfaces 144 of the first and second pipe sections 108a,b, respectively, thereby improving the seal between the first ridge sealing surface 426 of the first sealing ridge 416 and the outer pipe surface 144 of the first pipe section 108a and improving the seal between the second ridge sealing surface 428 of the second sealing ridge 418 and the outer pipe surface 144 of the second pipe section 108b. Providing the gasket outer surface 316 with the first and second gasket shoulders 318,320 can allow the first and second sealing ridges 416,418 to be biased further radially inward as the coupling segments 110 are tightened to accommodate pipe sections 108 of varying diameters, as opposed to traditional gaskets having a substantially flat gasket outer surface.

Moreover, when the coupling segments 110 are assembled around the annular gasket 310 and first and second pipe sections 108a,b, the grooved ends 142 of the first and second pipe sections 108a,b can extend into the coupling void 212 at the corresponding front and rear axial ends 116,118 of the coupling segments 110, respectively. The first and second arcuate keys 150,650 of the pipe coupling 106 can be aligned with the corresponding annular pipe groove 342 formed in the outer pipe surface 144 of the first and second pipe sections 108a,b, respectively.

As the pipe coupling 106 is tightened and the upper and lower coupling segments 110 are drawn towards one another, the first arcuate keys 150 at the front axial ends 116 of the coupling segments 110 can engage the annular pipe groove 342 of the first pipe section 108a and can grip the outer pipe surface 144 thereof. Similarly, the second arcuate keys 650 at the rear axial ends 118 of the coupling segments 110 can engage the annular pipe groove 342 of the second pipe section 108b and can grip the outer pipe surface 144 thereof. The pipe coupling 106 can thereby be clamped securely onto the pipe ends 140 of the first and second pipe sections 108a,b with the annular gasket 310 providing a fluid-tight seal therebetween. In some aspects, either or both of the upper and lower coupling segments 110a,b (lower coupling segment 110b shown in FIG. 1) can be configured to deform around the first and second pipe sections 108a,b to ensure that the coupling segments 110 have properly engaged the pipe sections 108 and to ensure that the annular gasket 310 is properly sealed against the outer pipe surface 144 of each of the first and second pipe sections 108a,b. In other aspects, the upper and lower coupling segments 110a,b may not deform at all around the first and second pipe sections 108a,b.

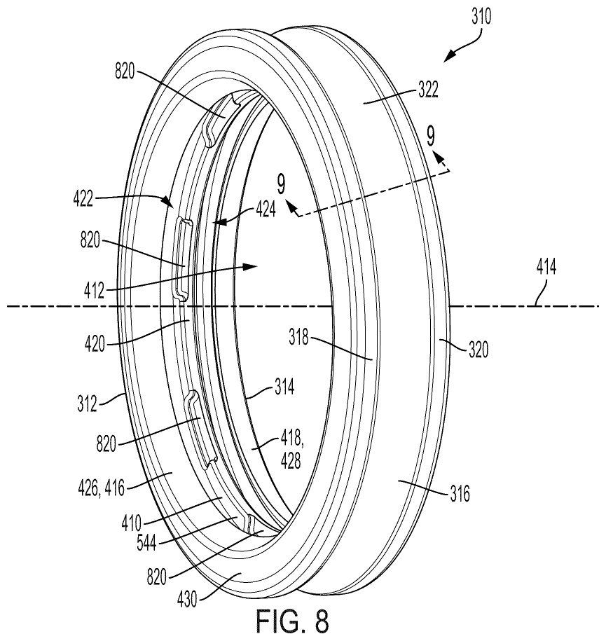

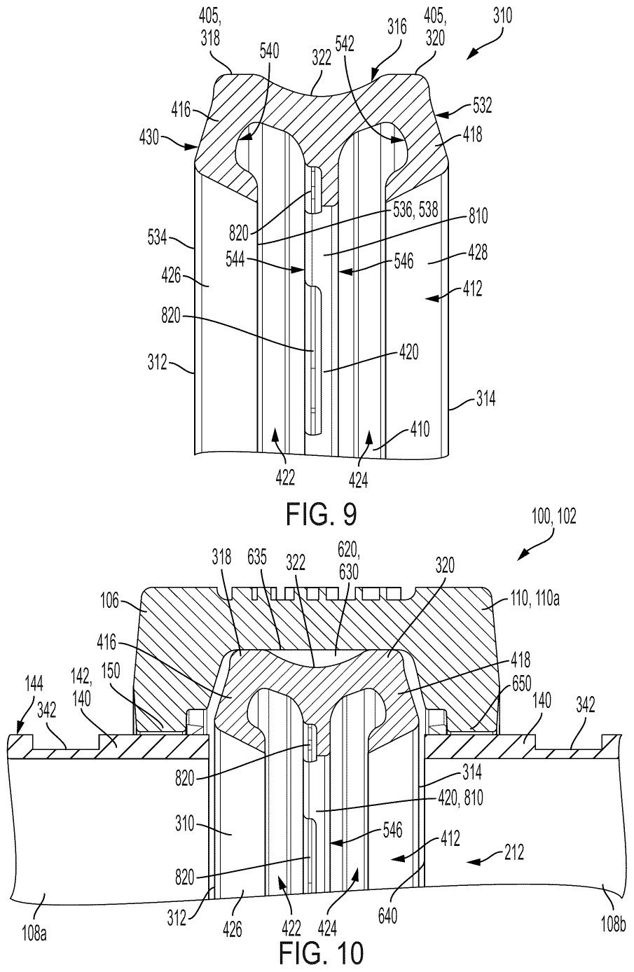

FIG. 8 illustrates the annular gasket 310 in accordance with another example aspect of the present disclosure, and FIG. 9 illustrates a cross-sectional view of the annular gasket 310 taken along line 9-9 in FIG. 8. The annular gasket 310 of the present aspect can comprise various similarities to the annular gasket 310 previously described. For example, referring to FIG. 8, the annular gasket 310 can define the gasket first axial end 312, the gasket second axial end 314, the gasket inner surface 410, and the gasket outer surface 316. The gasket inner surface 410 can define the gasket void 412, and the gasket axis 414 can extend centrally therethrough. The gasket outer surface 316 can define the first gasket shoulder 318 extending radially outward at the gasket first axial end 312, the second gasket shoulder 320 extending radially outward at the gasket second axial end 314, and the substantially concave gasket center groove 322 arranged axially therebetween.

The annular gasket 310 can further comprise the first sealing ridge 416, the second sealing ridge 418, the central rib 420, the first gasket channel 422, and the second gasket channel 424. The first sealing ridge 416 can extend radially inward from the first gasket shoulder 318 at the gasket first axial end 312, and the second sealing ridge 418 can extend radially inward from the second gasket shoulder 320 at the gasket second axial end 314. The gasket inner surface 410 can define the first ridge sealing surface 426 of the first sealing ridge 416 and the second ridge sealing surface 428 of the second sealing ridge 418. The central rib 420 can be arranged axially between the first sealing ridge 416 and the second sealing ridge 418 and can extend radially into the gasket void 412. In the present aspect, the central rib 420 can define one or more gasket recesses 820 extending axially inward into the first rib side surface 544 thereof. The gasket recesses 820 are described in further detail below with respect to FIG. 9. The first gasket channel 422 can be formed axially between the first sealing ridge 416 and the central rib 420, and the second gasket channel 424 can be formed axially between the second sealing ridge 418 and the central rib 420.

The first sealing ridge 416 can define the first outer ridge side surface 430 angling axially away from the central rib 420, and the second sealing ridge 418 can define the second outer ridge side surface 532 (shown in FIG. 9) angling axially away from the central rib 420. The first ridge sealing surface 426 of the first sealing ridge 416 can angle axially inward towards the central rib 420, and the second ridge sealing surface 428 of the second sealing ridge 418 can angle axially inward towards the central rib 420. As previously noted, in other aspects, the first and second outer ridge side surfaces 430,532 of the first and second sealing ridges 416,418 can be oriented substantially perpendicular to the gasket axis 414 and/or the first and second ridge sealing surfaces 426,428 of the first and second sealing ridges 416,418 can be oriented substantially parallel to the gasket axis 414 prior to installation with the first and second pipe sections 108a,b.

Referring now to FIG. 9, the axially outward end 534 of each of the first and second ridge sealing surfaces 426,428 can be rounded or chamfered in some aspects. The axially inward end 536 of each of the first and second ridge sealing surfaces 426,428 can terminate in the ridge tip 538, which can be substantially sharp or angular in some aspects. The first and second gasket channels 422,424 can be arranged axially inward from and proximate to the first and second sealing ridges 416,418, respectively. The first gasket channel 422 can extend into the first inner ridge side surface 540 of the first sealing ridge 416 to define the L-shape of the first sealing ridge 416, and the second gasket channel 424 can extend into the second inner ridge side surface 542 of the second sealing ridge 418 to define the L-shape of the second sealing ridge 418. The central rib 420 can be arranged axially between the first and second gasket channels 422,424 and can extend radially into the gasket void 412. The central rib 420 can define the first rib side surface 544 adjacent to the first gasket channel 422 and the second rib side surface 546 adjacent to the second gasket channel 424. The central rib 420 can further define a radially inward distal rib end 810 extending between the first rib side surface 544 and the second rib side surface 546.

As shown, the central rib 420 can define the one or more gasket recesses 820 extending axially inward into the first rib side surface 544 thereof. Thus, a width of the central rib 420 between the first rib side surface 544 and the second rib side surface 546 can be reduced at the location of each gasket recess 820. In the present aspect, the width of the central rib 420 at the location of one of the gasket recesses 820 can be about half of the width of the central rib 420 between the first rib side surface 544 and the second rib side surface 546. In some aspects, as shown, each of the gasket recesses 820 can further extend radially outward into the distal rib end 810 of the central rib 420. Each of the gasket recesses 820 can be elongated in a circumferential direction of the central rib 420 in some aspects. In other aspects, one or more of the gasket recesses 820 can also or alternatively extend axially into the second rib side surface 546. In other aspects, the gasket recesses 820 may not extend radially outward into the distal rib end 810. In other aspects, the gasket recesses 820 may not be elongated in the circumferential direction and/or can define any suitable size and shape.

Referring now to FIGS. 10 and 11, the coupling assembly 102 comprising the annular gasket 310 of FIGS. 8 and 9 can be assembled in substantially the same manner as previously described with respect to FIGS. 6 and 7. That is, the first and second pipe sections 108a,b can first be assembled with the annular gasket 310, and the coupling segments 110 of the pipe coupling 106 can then be assembled around the annular gasket 310 and first and second pipe sections 108a,b. The annular gasket 310 can define the first gasket shoulder 318 extending radially outward at the gasket first axial end 312, the second gasket shoulder 320 radially outward at the gasket second axial end 314, and the substantially concave gasket center groove 322 arcing radially inward between the first and second gasket shoulders 318,320. The annular gasket 310 can further define the first sealing ridge 416 extending radially inward from the first gasket shoulder 318, the second sealing ridge 418 extending radially inward from the second gasket shoulder 320, and the central rib 420 extending radially inward between the first sealing ridge 416 and the second sealing ridge 418. The central rib 420 can define the gasket recesses 820 formed at the first rib side surface 544. The first gasket channel 422 can be defined between the first sealing ridge 416 and the central rib 420, and the second gasket channel 424 can be defined between the second sealing ridge 418 and the central rib 420.

The pipe ends 140 of the first and second pipe sections 108a,b can be the grooved ends 142 each defining the corresponding annular pipe groove 342 and the inward pipe edge 640. To assemble the first and second pipe sections 108a,b with the annular gasket 310, the pipe end 140 of the first pipe section 108a can be inserted into the gasket void 412 at the gasket first axial end 312 to abut and seal the inward pipe edge 640 of the first pipe section 108a against the first rib side surface 544 of the central rib 420, and the pipe end 140 of the second pipe section 108b can be inserted into the gasket void 412 at the gasket second axial end 314 to abut and seal the inward pipe edge 640 of the second pipe section 108b against the second rib side surface 546 of the central rib 420. As the central rib 420 is compressed between the inward pipe edges 640 of the first and second pipe sections 108a,b, the resilient material of the central rib 420 can extrude into the gasket recesses 820 formed in the central rib 420. Additionally, as the first and second pipe sections 108a,b are inserted into the gasket void 412, the first ridge sealing surface 426 of the first sealing ridge 416 can contact and seal against the outer pipe surface 144 of first pipe section 108a, and the second ridge sealing surface 428 of the second sealing ridge 418 can contact and seal against the outer pipe surface 144 of the second pipe section 108b.

Once the first and second pipe sections 108a,b are assembled with the annular gasket 310, the coupling segments 110 of the pipe coupling 106 can be assembled around the annular gasket 310 in the untightened configuration, with the annular gasket 310 received within the substantially annular coupling channel 635 between the first and second arcuate keys 150,650.

The pipe coupling 106 can then be tightened around the annular gasket 310 and the pipe ends 140 of the first and second pipe sections 108a,b, as previously described, by tightening the fasteners 130 (shown in FIG. 1) to draw the coupling segments 110 towards one another and reduce the diameter of the coupling void 212. As previously described, prior to tightening, in the untightened configuration, in some aspects, the first gasket shoulder 318 and the second gasket shoulder 320 can bias the first coupling segment away 110a from the second coupling segment 110b and/or away from the first pipe section 108a and the second pipe section 108b.

As shown in FIG. 11, as the coupling segments 110 are drawn towards one other, the annular gasket 310 can be compressed between the pipe coupling 106 and the first and second pipe sections 108a,b to improve the seal of the annular gasket 310 with the first and second pipe sections 108a,b. The coupling inner surface 630 of the pipe coupling 106 can engage and press against the first and second gasket shoulders 318,320 of the annular gasket 310 to bias the first and second sealing ridges 416,418 radially inward against the outer pipe surfaces 144 of the first and second pipe sections 108a,b, respectively, thereby improving the seal between the first ridge sealing surface 426 of the first sealing ridge 416 and the outer pipe surface 144 of the first pipe section 108a and improving the seal between the second ridge sealing surface 428 of the second sealing ridge 418 and the outer pipe surface 144 of the second pipe section 108b. As previously described, providing the first and second gasket shoulders 318,320 can allow the first and second sealing ridges 416,418 to be biased further radially inward as the coupling segments 110 are tightened to accommodate pipe sections 108 of varying diameters, as opposed to traditional gaskets having a substantially flat gasket outer surface.

Additionally, as the pipe coupling 106 is tightened and the upper and lower coupling segments 110a,b (lower coupling segment 110b shown in FIG. 1) are drawn towards one another, the first arcuate keys 150 at the front axial ends 116 of the coupling segments 110 can engage the annular pipe groove 342 of the first pipe section 108a and can grip the outer pipe surface 144 thereof. Similarly, the second arcuate keys 650 at the rear axial ends 118 of the coupling segments 110 can engage the annular pipe groove 342 of the second pipe section 108b and can grip the outer pipe surface 144 thereof. The pipe coupling 106 can thereby be clamped securely on the pipe ends 140 of the first and second pipe sections 108a,b with the annular gasket 310 providing a fluid-tight seal therebetween. In some aspects, either or both of the upper and lower coupling segments 110a,b, can be configured to deform around the first and second pipe sections 108a,b to ensure that the coupling segments 110 have properly engaged the pipe sections 108 and to ensure that the annular gasket 310 is properly sealed against the outer pipe surface 144 of each of the first and second pipe sections 108a,b.

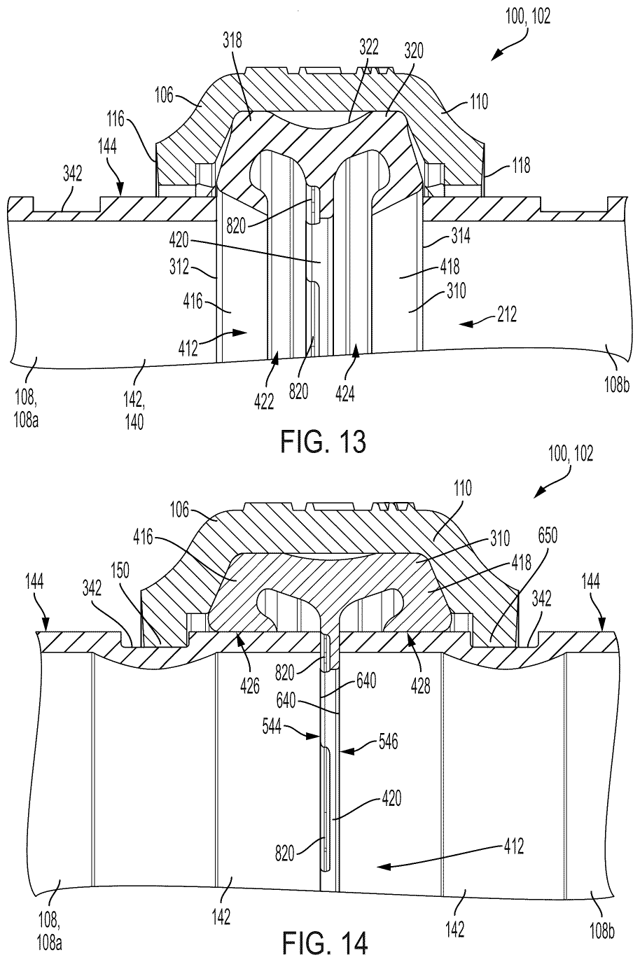

FIGS. 12-14 illustrate the coupling assembly 102 according to another example aspect of the disclosure. The coupling assembly 102 is shown in the untightened configuration in FIGS. 12 and 13 and in the tightened configuration in FIG. 14. The coupling assembly 102 can comprise the pipe coupling 106, the annular gasket 310 (shown in FIG. 13), and the first and second pipe sections 108a,b.

Referring to FIG. 13, the annular gasket 310 in the present aspect can be substantially the same as the annular gasket 310 of FIGS. 8-11. That is, the annular gasket 310 can comprise the first and second gasket shoulders 318,320, the gasket center groove 322, the first and second sealing ridges 416,418, the first and second gasket channels 422,424, and the central rib 420 defining the gasket recesses 820. Moreover, the first and second pipe sections 108a,b can be substantially the same as previously described. That is, each of the first and second pipe sections 108a,b can comprise the grooved end 142 defining the annular pipe groove 342 formed in the outer pipe surface 144 thereof.

However, the coupling assembly 102 of the present aspect can be assembled in a manner different from the aspects of FIGS. 1-11. In the present aspect, the coupling segments 110 and the annular gasket 310 can be pre-assembled in the untightened configuration (i.e., with either or both of the fasteners 130, shown in FIG. 12, loosened). The pre-assembled pipe coupling 106 and annular gasket 310 can be placed onto and slid over the first pipe section 108a by receiving the grooved end 142 of the first pipe section 108a into the coupling void 212 at the front axial ends 116 of the coupling segments 110 and into the gasket void 412 at the gasket first axial end 312 of the annular gasket 310. The second pipe section 108b can then be aligned with the first pipe section 108a, and the pre-assembled pipe coupling 106 and annular gasket 310 can be slid back over the second pipe section 108b, receiving the grooved end 142 of the second pipe section 108b into the coupling void 212 at the rear axial ends 118 of the coupling segments 110 and into the gasket void 412 at the gasket second axial end 314 of the annular gasket 310.

Referring to FIG. 14, as the grooved ends 142 of the first and second pipe sections 108a,b are received into the gasket void 412, the inward pipe edge 640 of the first pipe section 108a can abut and seal with the first rib side surface 544 of the central rib 420, and the inward pipe edge 640 of the second pipe section 108b can abut and seal with the second rib side surface 546 of the central rib 420. The resilient material of the central rib 420 can extrude into the gasket recesses 820 as the central rib 420 is compressed between the first and second pipe sections 108a,b. Additionally, as the first and second pipe sections 108a,b are inserted into the gasket void 412, the first ridge sealing surface 426 of the first sealing ridge 416 can contact and seal against the outer pipe surface 144 of first pipe section 108a, and the second ridge sealing surface 428 of the second sealing ridge 418 can contact and seal against the outer pipe surface 144 of the second pipe section 108b. The pipe coupling 106 can then be tightened as previously described to engage the first and second arcuate keys 150,650 with the annular pipe grooves 342 of the corresponding first and second pipe sections 108a,b, respectively, and to increasingly bias the first and second sealing ridges 416,418 against the outer pipe surface 144 of the first and second pipe sections 108a,b, respectively.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

1. An annular gasket for a fitting assembly, the annular gasket comprising:
a gasket inner surface defining a gasket void and a central rib extending radially inward into the gasket void, a gasket axis extending centrally through the gasket void;
a gasket outer surface defining a first gasket shoulder extending radially outward at a first axial end of the annular gasket and a second gasket shoulder extending radially outward at a second axial end of the annular gasket opposite the first axial end;
a first sealing ridge extending radially inward at the first axial end of the annular gasket and comprising a first ridge sealing surface extending axially inward toward the central rib; and
a second sealing ridge extending radially inward at the second axial end of the annular gasket and comprising a second ridge sealing surface extending axially inward toward the central rib, wherein the central rib is positioned axially between the first sealing ridge and the second sealing ridge.

2. The annular gasket of claim 1, wherein the gasket outer surface further defines a substantially concave gasket center groove positioned axially between the first gasket shoulder and the second gasket shoulder and arcing radially inward therefrom.

3. The annular gasket of claim 1, wherein:
the gasket inner surface further defines a first ridge sealing surface of the first sealing ridge and a second ridge sealing surface of the second sealing ridge;
the first ridge sealing surface is configured to seal with a first piping component;
the second ridge sealing surface is configured to seal with a second pipe component; and
the central rib is configured to be compressed axially between the first piping component and the second piping component.

4. The annular gasket of claim 3, wherein the gasket inner surface further defines a first gasket channel positioned axially between the first sealing ridge and the central rib and a second gasket channel positioned channel axially between the second sealing ridge and the central rib.

5. The annular gasket of claim 4, wherein:
the central rib defines a first rib side surface adjacent to the first gasket channel, a second rib side surface adjacent to the second gasket channel, and a radially inward distal rib end extending between the first rib side surface and the second rib side surface;
the first rib side surface is configured to contact and seal with the first piping component; and
the second rib side surface is configured to contact and seal with the second pipe component.

6. The annular gasket of claim 5, wherein the central rib defines a plurality of gasket recesses extending axially inward into the first rib side surface such that a width of the central rib between the first rib side surface and the second rib side surface is greater than a width of the central rib at each of the plurality of gasket recesses.

7. The annular gasket of claim 6, wherein the annular gasket comprises a resilient material, and wherein the resilient material is configured to extrude into the plurality of gasket recesses upon compression of the central rib between the first piping component and the second piping component.

8. The annular gasket of claim 7, wherein each of the plurality of gasket recesses further extends radially outward into the radially inward distal rib end of the central rib.

9. A fitting assembly comprising:
a pipe fitting comprising a first fitting segment and a second fitting segment, the first and second fitting segments defining a fitting inner surface of the pipe fitting, the fitting inner surface defining a coupling void and a substantially annular coupling channel; and
an annular gasket received with the substantially annular coupling channel, the annular gasket defining a gasket outer surface, the gasket outer surface defining a first gasket shoulder and a second gasket shoulder, the annular gasket further comprising a first sealing ridge extending radially inward from the first gasket shoulder and a second sealing ridge extending radially inward from the second gasket shoulder, the annual gasket further defining a gasket inner surface opposite the gasket outer surface; the gasket inner surface further defined a first ridge sealing surface of the first sealing ridge and a second ridge sealing surface of the second sealing ridge, wherein the gasket inner surface further defines a central rib arranged axially between the first sealing ridge and the second sealing ridge and extending radially inward into the coupling void, the central rib defines a first rib side surface adjacent to the first gasket channel, an opposite second rib side surface adjacent to the second gasket channel, and a radially inward distal rib end extending between the first rib side surface and the second rib side surface, wherein the central rib defines a plurality of gasket recesses extending axially inward into the first rib side surface such that a width of the central rib between the first rib side surface and the second rib side surface is greater than a width of the central rib at each of the plurality of gasket recesses;
wherein the fitting assembly is configurable in an untightened configuration and a tightened configuration, and wherein, in the tightened configuration, the fitting inner surface is pressed against the first gasket shoulder and the second gasket shoulder to bias the first sealing ridge and the second sealing ridge radially inward.

10. The fitting assembly of claim 9, wherein the gasket outer surface further defines a substantially concave gasket center groove positioned axially between the first gasket shoulder and the second gasket shoulder and arcing radially inward therefrom.

11. The fitting assembly of claim 9, wherein:
the first ridge sealing surface is configured to seal with a first piping component; and
the second ridge sealing surface is configured to seal with a second pipe component.

12. The fitting assembly of claim 11, wherein:
the central rib is configured to be compressed axially between the first piping component and the second piping component.

13. The fitting assembly of claim 12, wherein:
each of the first fitting segment and the second fitting segment define a first arcuate key at a segment first axial end thereof and a second arcuate key at an opposite segment second axial end thereof;
the annular gasket and the substantially annular coupling channel are arranged axially between the first arcuate keys and the second arcuate keys;
the first arcuate keys are configured to grip the first piping component in the tightened configuration; and
the second arcuate keys are configured to grip the second piping component in the tightened configuration.

14. The fitting assembly of claim 12, wherein the gasket inner surface further defines a first gasket channel positioned axially between the first sealing ridge and the central rib and a second gasket channel positioned channel axially between the second sealing ridge and the central rib.

15. The fitting assembly of claim 14, wherein:
the first rib side surface is configured to contact and seal with the first piping component; and
the second rib side surface is configured to contact and seal with the second pipe component.

16. (canceled)

17. The fitting assembly of claim 15, wherein the annular gasket comprises a resilient material, and wherein the resilient material is configured to extrude into the plurality of gasket recesses upon compression of the central rib between the first piping component and the second piping component.

18. The fitting assembly of claim 17, wherein each of the plurality of gasket recesses further extends radially outward into the radially inward distal rib end of the central rib.

19. A method of assembling a fitting assembly, the method comprising:
providing an annular gasket, the annular gasket defining a gasket outer surface and a gasket inner surface, the gasket outer surface defining a first gasket shoulder extending radially outward at a first axial end of the annular gasket and a second gasket shoulder extending radially outward at a second axial end of the annular gasket, the annular gasket further comprising a first sealing ridge extending radially inward from the first gasket shoulder and a second sealing ridge extending radially inward from the second gasket shoulder, the first sealing ridge comprising a first ridge sealing surface extending axially inward toward the central rib and the second sealing ridge comprising a second ridge sealing surface extending axially inward toward the central rib, the inner gasket surface defining a gasket void;
inserting a first end of a first piping component into the gasket void at a first gasket axial end of the annular gasket such that the first ridge sealing surface contacts an outer surface of the first piping component;
inserting a second end of a second pipe component into the gasket void at a second gasket axial end of the annular gasket, opposite the first gasket axial end, such that the second ridge sealing surface contacts an outer surface of the second piping component; and
tightening a pipe fitting around the annular gasket to press the pipe fitting radially inward against the first gasket shoulder and the second gasket shoulder;
wherein pressing the pipe fitting radially inward against the first gasket shoulder and the second gasket shoulder comprises biasing the first sealing ridge and the second sealing ridge radially inward to seal against the first sealing ridge against the first pipe component and the second sealing ridge against the second pipe component.

20. The method of claim 19, wherein:
the method further comprises compressing the central rib between the first end of the first piping component and the second end of the second piping component.

21. The annular gasket of claim 1, wherein a plurality of gasket recesses can be elongated in a circumferential direction of the central rib.
